(19) United States
(12) Patent Application Publication
(10) Pub. No.: US 2009/0028230 A1
(43) Pub. Date: Jan. 29, 2009

(54) Method and apparatus for improving quality of service for reception in digital television broadcast systems

(75) Inventor: Kip Leitner, Philadelphia, PA (US)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/878,841

(22) Filed: Jul. 27, 2007

(51) Int. Cl. H04B 17/00; H04B 3/46; H04Q 1/20

(52) U.S. Cl. 375/224

(57) ABSTRACT

A method of transmitting a digital data stream to a receiver unit. The method includes the steps of modulating a digital data stream in accordance with a modulation technique so as to generate a modulated digital data stream; providing the modulated digital data stream to a transmitter unit operable for transmitting the modulated digital data stream; receiving the transmitted digital data stream by the receiver unit, where the receiver unit generates signal reception data indicating the quality of reception of the modulated digital data stream; and providing the signal reception data indicating the quality of reception of the modulated digital data stream to a quality control processing unit via a communication channel, where the quality control processing unit analyzes the signal reception data to determine if the quality of reception of the modulation digital data stream by the receiver unit is below a predefined level, and if so, adjusts the modulation technique being applied so as to improve the quality of reception by the receiver unit.

### FIELD OF THE INVENTION

The present invention relates to a method and apparatus for optimizing the quality of reception of receiver units in a digital television broadcast system, and more particular, for optimizing the quality of a group of over-the-air (OTA) broadcast streams utilized to provide content to the receiver units.

### BACKGROUND OF THE INVENTION

The use of digital transmission systems in conjunction with digital television (DTV) and high-definition television (HDTV) are becoming well known in the prior art. An example of an digital television system is disclosed in U.S. Pat. No. 7,206,352, the entirety of which is incorporated herein by reference. Such systems are typically compatible with the Advanced Television Systems Committee (ATSC) Digital Television (DTV) standards.

Current digital transmission systems allow the DTV signal, which is output by a transmitter and which delivers content to the receivers, to be received in large geographical (i.e., reception) areas. As a result, there has been an effort to improve the transmit range of DTV systems by utilizing different modulation schemes so as to provide improved reception across the large geographical areas. For example, such enhancements include using digital modulation patterns other than the current 8-vestigial sideband (VSB) mode, such as E-VSB, 4-VSB and 2-VSB. These alternative modulation schemes in combination with the use of forward error correction (FEC) transmission and improved reception systems help increase the effective range at which a DTV signal can be received.

In the process of deploying these new modulation techniques/schemes for widespread use, substantial field testing is required to determine the effective transmit and receive range of each transmission mode for each receiver unit. Further, the effective range has to be quantified as the furthest point of reception from the transmitter, under the most degraded OTA atmospheric conditions. This process, which can be both time consuming and costly, is necessary so as to allow for acceptable transmission to the receiver located farthest from the transmitter under the most adverse atmospheric conditions to be expected.

However, most of the time, the communications channel is not highly degraded, and therefore, it is not necessary to transmit the DTV signal with the same modulation as would be required for acceptable reception under worst case conditions. In other words, under typical channel conditions, equivalent quality reception can be achieved utilizing, for example, a less intensive FEC technique, which results in a reduction of the bandwidth required for the given signal, thereby “freeing-up” OTA bandwidth for other uses. As such, current systems do not provide for efficient use of the available system bandwidth as the bandwidth is set to accommodate worst case conditions.

Accordingly, there is a need for a method and a system which can dynamically change the bandwidth allocated to the digital television broadcast streams so as to allow variations in the modulation technique/scheme utilized for the given broadcast stream to ensure proper reception of the broadcast stream by all receivers in the given geographical area under varying conditions so as to provide a more efficient use of the overall system bandwidth.

### SUMMARY OF THE INVENTION

In view of the foregoing, it is a primary objective of the present invention to provide a method and system for optimizing the quality of reception of receiver units in a digital television broadcast system which overcomes the foregoing problems associated with the prior art systems. Specifically, one objective is to provide a method and system for periodically or continually optimizing the modulation technique/scheme utilized to transmit the broadcast streams to the various receiver units under specific and/or changing transmission conditions, which can be affected, for example, by weather. By performing such an optimization, it is possible to dynamically adjust the modulation being utilized to transmit the data signals so as to ensure proper reception of the data signals by all of the receiver units under changing atmospheric conditions.

According to one embodiment, the present invention relates to a method of transmitting a digital data stream to a receiver unit. The method includes the steps of modulating a digital data stream in accordance with a modulation technique so as to generate a modulated digital data stream; providing the modulated digital data stream to a transmitter unit operable for transmitting the modulated digital data stream; receiving the transmitted digital data stream by the receiver unit, where the receiver unit generates signal reception data indicating the quality of reception of the modulated digital data stream; and providing the signal reception data indicating the quality of reception of the modulated digital data stream to a quality control processing unit via a communication channel, where the quality control processing unit analyzes the signal reception data to determine if the quality of reception of the modulation digital data stream by the receiver unit is below a predefined level, and if so, adjusts the modulation technique being applied so as to improve the quality of reception by the receiver unit.

The present invention also relates to a system for transmitting a digital data stream. The system includes: a modulation unit for receiving the digital data stream and modulating the digital data stream in accordance with a modulation technique; a transmitter unit for transmitting the modulated digital data stream; a receiver unit for receiving the transmitted modulated digital data stream, where the receiver unit generates signal reception data indicating the quality of reception of the modulated digital data stream; a quality control processing unit for analyzing the signal reception data to determine if the quality of reception of the modulated digital data stream received by the receiver unit is below a predefined level; and a communication channel for coupling said receiver unit to the quality control processing unit, where the signal reception data is provided to the quality control processing unit via the communication channel;

The present invention provides significant advantages over prior art systems. One advantage is that the present invention provides a method and system for dynamically optimizing the modulation technique utilized to transmit the broadcast streams to the various receiver units under specific and/or changing transmission conditions, which can be affected, for example, by weather, thereby allowing for the dynamic optimization of bandwidth being utilized by the system and system power requirements during operation. As a result, the system provides for improved efficiency and a significant cost savings, while simultaneously minimizes the possibility of content delivery failures.

Another advantage associated with the present invention is that the aggregate performance data can be utilized as a baseline to determine the overall quality of reception over an extended period of time. Such data can be utilized to provide additional information regarding DTV OTA reception.

Additional objects, advantages, and novel features of the invention will become apparent to those skilled in the art upon examination of the following description, or may be learned by practice of the invention. While the novel features of the invention are set forth below, the invention, both as to organization and content, will be better understood and appreciated, along with other objects and features thereof, from the following detailed description taken in conjunction with the drawings.

### BRIEF DESCRIPTION OF THE DRAWINGS

The accompanying drawings, which are incorporated into and form a part of the specification, illustrate several aspects and embodiments of the present invention and, together with the general description given above and detailed description given below, serve to explain the principles of the invention. Such description makes reference to the annexed drawings. The drawings are only for the purpose of illustrating preferred embodiments of the invention and are not to be treated as limiting the invention.

FIG. 1 illustrates an exemplary block diagram of the broadcast system of the present invention.

FIG. 2 illustrates a detailed exemplary block diagram of the broadcast system of the present invention.

FIG. 3 illustrates an exemplary flowchart which sets forth the optimization process performed by the present invention.

Throughout the above-mentioned drawings, identical reference numerals are used to designate the same or similar component parts.

### DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein: rather, these embodiments are provided so that this disclosure will be thorough and complete, and will fully convey the scope of the invention to those skilled in the art; like numbers refer to like elements throughout.

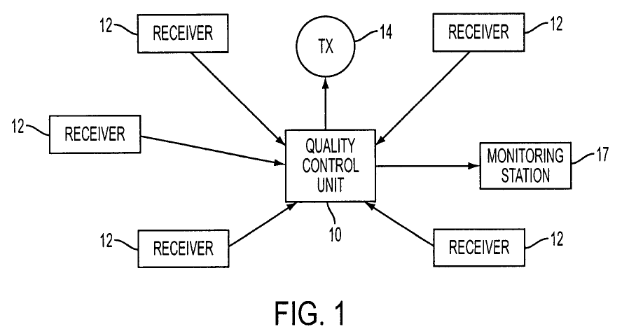

The present invention relates to a system and method for dynamically optimizing the quality of reception of a group of over-the-air (OTA) ATSC broadcast streams (digital television). Referring to FIG. 1, which is an exemplary block diagram, the system includes a quality control processing unit 10, a plurality of “fixed placement” receiver units 12, at least one transmitter unit 14 and a monitoring unit 17. In operation, the quality control processing unit 10 controls the broadcast data stream (e.g., video content) to be transmitted by the transmitter unit 14, as well as the encoding and/or modulation scheme to be utilized to transmit the broadcast data stream via the transmitter 14. The transmitted broadcast data stream is received by each of the receiver units 12 located in the given geographical area. It is noted that in the given embodiment the receivers are fixed in permanent locations and therefore not mobile or moving during operation.

Upon receipt of the broadcast data stream, in addition to processing and recreating the transmitted data signal (e.g., digital video signal) as is performed by standard receivers, each of the receiver units 12 is capable of determining the quality of reception of the received broadcast data stream. The quality of reception can differ among the receiver units 12 due to, for example, localized weather conditions or atmospheric conditions, as well as fixed obstacles affecting receipt of the data stream by a given receiver unit 12. Once the quality of reception is determined by each receiver unit 12, each receiver unit 12 transmits this information back to the processing unit 10, for example, by a wide-area network (WAN) link, which may utilize a wireless and/or hardwired communications channel. Upon receiving the quality of reception information from each of the receiver units 12, the quality control processing unit 10 utilizes this information to determine the optimal modulation scheme and error correction, including data robustness and bit-rate, for each of transmitted data streams necessary for each of the receiver units 12 to properly receive the data stream intended for the given receiver unit 12. Thus, the present invention allows for dynamically changing the bandwidth allocated to a collection of ATSC OTA broadcast streams in order to improve the overall service (i.e., quality of reception) associated with the broadcast streams being received by the receiver units 12.

Typically, in a digital transmission, technical performance is correlated with the overall Bit Error Rate (BER) exhibited by the receiver unit 12. In certain problematic reception environments or areas, the BER increases to the point that a digital receiver unit 12 begins to fail, and is unable to receive the signal properly. When a receiver unit 12 fails in this manner, the received stream data—either audio or video—is unrecoverable and the overall service fails.

In order to increase the transmission range of the system, a transmission method specified as “A-VSB” has been added to the ATSC standard. As is known, A-VSB contains the usual 8-VSB streams as well as enhanced streams using different FEC, such as E-VSB, 4-VSB or 2-VSB. Transmission of A-VSB data is backward compatible with existing 8-VSB receivers. A-VSB transmissions are encoded in a more robust manner than 8-VSB transmission using enhanced Forward Error Correction (FEC), and as a result, can be received at greater distances by an A-VSB-capable receiver unit. It is noted that while it is preferable to utilize receiver units 12 which are A-VSB compatible so as to increase the available transmission range of the system, the present invention is not limited to A-VSB compatible receiver units.

It is further noted that digital reception in either fringe or fading areas can be problematic and continually changing. For example, in fringe areas, the signal-to-noise ratio (SNR) may become so small that the background noise disrupts reception. Further, fading reception is a generalized descriptor that includes different forms of RF degradations, which may also disrupt reception. Examples of different forms of signal fading are Rayleigh, Rician and Suzuki, which themselves are characterized by certain specific aggregations of the main RF signal (which may not be present due to line of sight problems) and reflected multipath signals.

However, in such geographical areas of marginal RF reception, it is possible to quantify the degree to which a receiver unit 12 is able to receive a transmission (i.e., incoming signal) utilizing various metrics. For example, the SNR or BER of the received signal can be utilized as the metric to indicate the quality of reception of the received signal. As another example, the metric can be based on the loss of the training sequence, which on a VSB modulated signal is a specific digital pattern of 0's and 1's. It is noted that the system may utilize any acceptable and available metric to determine signal reception performance by the receiver and is not limited to utilizing the SNR or BER.

As noted above, and explained in further detail below, the system of the present invention forwards this signal reception performance data back to the quality control processing unit 10 via a communications channel, and the quality control processing unit 10 utilizes this information to determine which modulation and error correction technique to utilize as well as how to apportion its available bandwidth in view of the current performance conditions regarding reception of the transmitted signal.

In addition, the quality control processing unit 10, by polling the signal reception performance data from among its pool of available receiver units 12, can determine the robustness and bit rates, for example, of an A-VSB transmission necessary to delineate to content providers different levels of robustness in fringe reception areas. As such, the system provides the ability for a broadcaster to dynamically allocate transmit bandwidth and deliver programming to fringe areas based on communications channel feedback from the receiver units 12. Furthermore, the system has the capacity to automate reception testing utilizing the feedback channel on which the signal reception performance data is provided to the quality control processing unit 10, which in prior art system has traditionally been done via mobile reception labs.

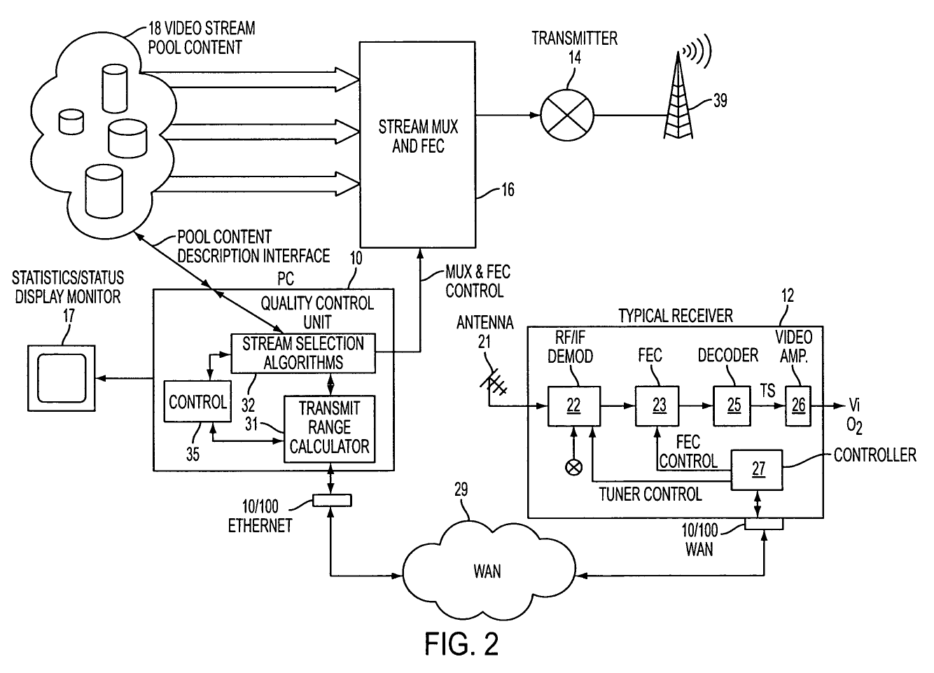

FIG. 2 illustrates a more detailed exemplary block diagram of the broadcast system of the present invention. The system includes the quality control processing unit 10, an exemplary receiver unit 12, a transmitter unit 14, a multiplexer unit 16 and a video stream pool content device 18. Referring to FIG. 2, the receiver unit 12 includes an antenna 21 for receiving the signal broadcast by the transmitter unit 14, a demodulator 22 for converting the incoming signal to an IF frequency, a forward error correction (FEC) circuit 23 having an input coupled to the output of the demodulator 22 and an output coupled to the input of a decoder 25, a video amplifier 26 for receiving the output of the decoder 25 and for generating a video signal corresponding to the signal transmitted by the transmitter unit 14, and a controller 27 coupled to the demodulator 22 so as to provide a tuner control signal to the demodulator 22. The controller 27 is also coupled to the FEC circuit 23 so as to provide a control signal to the FEC circuit 23; and to the decoder 25 so as to control the decoding operation as well as receive the decoded signal from the decoder 25. Further, the controller 27 also includes communications network capabilities, for example, a wide-area-network (WAN), which allows the signal reception data to be communicated back to the quality control processing unit 10 via a communications network 29. It is noted that the controller 27, which typically includes a microprocessor or CPU, can be configured to either forward back raw data concerning the received signal, or can be configured to compute a metric associated with the quality of reception, in which case only the data of the metric being utilized to determine the quality of the received signal would be sent back to the quality control processing unit 10 via the communication link 29. It is noted that the demodulator 22, FEC circuit 23, decoder 25 and video processor 26 are standard components found in typical receiver devices.

Referring again to FIG. 2, the quality control processing unit 10 includes a controller 35 and a transmit range calculation unit 31, and a stream selection unit 32, both of which are under control of controller 35. The quality control processor unit 10 communication network capabilities, which are compatible with the communication network of the receiver unit 12 so as to allow the receiver unit 12 and the quality control processing unit 10 to be in communication with one another. Both the transmit calculation unit 31 and the stream selection unit 32 can be implemented in separate CPU devices or dedicated ASICs. However, it is also possible to implement the transmit range calculation unit 31 and the stream selection unit 32 in a single CPU or microprocessor device. As explained in further detail below, in operation the quality control processing unit 10 polls or receives data from the receiver unit 12 regarding the quality of signal reception being experienced by the receiver unit 12. Based on the signal reception data, the transmit range calculator unit 31 determines the maximum allowable transmission range of the transmit signal under the given conditions. For example, based on the signal reception data fed back by the receiver unit 12, by knowing the current transmission settings, including for example, the modulation scheme being utilized and transmission power levels, as well as the available modulation schemes and transmission power levels of the system, the maximum transmission range of the given system can be calculated. As one example, a predefined look-up table can be generated based on data including but not limited to quality of received signal, modulation technique, error correction technique and transmission power, where the result of the look-up table indicates the maximum transmission range for a given combination of data. Interpolation techniques may be utilized to determine results for specific data points not specified in the look-up table. The look-up table can be stored in memory and accessed by the transmit range calculation unit 31 when necessary.

The controller 35 and stream selection unit 32, which receive the maximum range data output by the transmit calculation unit 31, determine which transmission scheme, (e.g., modulation and error correction scheme) to utilize for the given transmission such that the transmitted signal can be properly received by the all of the receivers in the given broadcast area. While there are numerous methods of determining which modulation and error correction scheme to utilize based on the maximum range data provided by transmit range calculation unit 31, one such example utilizes the predefined look-up table noted above. Specifically, for example, as the desired transmission distance is known due to the receiver units 12 having fixed locations, the stream selection unit 32 can access the look-up table to determine if any combination of available modulation and error correction techniques will provide the necessary transmission distance under the current atmospheric conditions. If so, this modulation and error correction scheme is selected and a multiplexer and FEC unit 16 is commanded to multiplex and encode the data streams in accordance with the selected techniques.

As noted above, the location of the receiver unit 12 are fixed and therefore their location relative to the transmitter unit 14 can be stored in memory in the quality control processing unit 10, or the location information of each of the receiver units 12 can be transmitted back to the quality control processing unit 10 by the communications network 29.

As mentioned above, the system further includes a multiplexer and FEC unit 16 which receives data streams to be transmitted as a first input signal and a control signal from the quality control processing unit 10 as a second input signal. As shown, the control signal is output by the stream selection algorithm unit 32 and coupled to the multiplexer and FEC unit 16. The data streams input to the multiplexer and FEC unit 16 are provided, for example, by a content provider utilizing the system to broadcast the data streams to the receiver units 12 in the given broadcast area. In operation, the multiplexer and FEC unit 16 operates to format and multiplex the data streams to be transmitted so as to implement the modulation and error correction scheme determined to be optimal by the quality control processing unit 10. It is noted that video stream data to be transmitted may be stored in memory within the system prior to transmission of the data. Further, the quality control processing unit 10 may have access to such data stored in memory via an interface between the quality control processing unit and the memory. It is noted that the multiplexer and FEC unit 16 utilize standard components typically found in such modulation units capable of modulating and transmitting digital video data.

The output of the multiplexer and FEC unit 16 is coupled to a transmitter unit 14, which functions to broadcast the data streams to the receiver units 12 within the broadcast area via an antenna 39. It is noted that the transmitter unit 14 includes standard components found in a transmitter capable of transmitting data streams containing video data for digital television.

Finally, as an optional feature, the system may further include a display monitor 17, which is coupled to the quality control processing unit 10. The display monitor allows the operator to view items such as, but not limited to, the current communication performance level of the receiver units 12, the modulation and error correction scheme currently being utilized, the alternative modulation and error correction schemes available for use, the current maximum range for successful transmission under the current conditions, as well as the transmission range associated with the alternative modulation and error correction schemes available for use. It is noted that in the preferred embodiment, in addition to the display monitor, the system includes an operator input device (e.g., a keypad) which allows the operator to input and communicate with the quality control processing unit 10 such that the controller 35 contained in the quality control processing unit 10 will calculate and/or generate the requested information and display such information on the monitor 17. In addition, the input device could be utilized by the operator to command the quality control processing unit 10 to select a specific modulation and error correction scheme to be utilized.

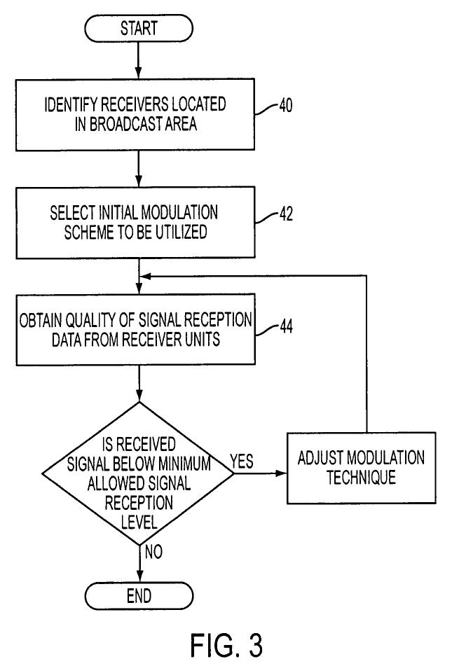

FIG. 3 illustrates an exemplary flowchart which assists in the explanation of the operation of the system. Referring to FIG. 3, the first step (Step 40) in the process is to identify the receivers located in the given broadcast area (i.e., the receivers that the transmitted signal is expected to reach), and the location of the receivers (i.e., distance from the transmitter). The next step in the process (Step 42) is to select an initial modulation and error correction scheme to be utilized to transmit the data streams. For example, the initial modulation and error correction technique can be selected so that the transmitted signal should reach the farthest receiver unit under normal operating (e.g., environmental) conditions. The next step in the process (Step 44) is to obtain the quality of signal reception data from the receiver units 12. In the given embodiment, the quality control processing unit 10 polls each of the receiver units 12 via the communication channel 29 requesting the receiver units 12 to forward the data to the quality control processing unit 10. However, it is also possible for the receiver units 12 to automatically forward the data back to the quality control processing unit 10. In addition, it is also possible to selectively poll or have select receiver units 12 transmit the requested data such that the quality control processing unit 10 only receives quality of signal reception data from the receiver units 12 which are expected to have reception issues, for example, due to the distance from the transmitter. Once the quality of signal reception data is received by the quality control processing unit 10, in the next step (Step 46) the data is analyzed by the quality control processing unit 10 to determine if any of the receiver units 12 are below the minimum signal reception levels necessary to ensure proper reception of the transmitted data stream. If the answer is NO, the process is completed as the current modulation and error correction being utilized is sufficient to allow each of the receiver units 12 to properly receive the transmitted data stream. If the answer is YES, in Step 48, the quality control processing unit 10 functions to change the modulation and error correction being utilized to encode the data streams to be transmitted so as to increase the quality of reception at the receiver units 12. The process then returns to Step 44 and repeats Steps 44 and 46 again until all receiver units 12 indicate the signal reception quality is above a minimum level. It is noted that the overall process illustrated in FIG. 3 can also be run periodically so as to account for changes in the environmental conditions due to, for example, changes in weather.

The present invention provides significant advantages over prior art systems. For example, the present invention provides a method and system for dynamically optimizing the modulation technique utilized to transmit the broadcast streams to the various receiver units under specific and/or changing transmission conditions, which can be affected, for example, by weather, thereby allowing for the dynamic optimization of bandwidth being utilized by the system and system power requirements during operation. As a result, the system provides for improved efficiency and a significant cost savings.

Another advantage is that the quality control processing unit is capable of sending diagnostic data and summaries of the receiver and transmission performance to a remote monitoring station via the communications channel 29. Such data can be utilized by an operator, for example, to adjust overall system operation.

Variations of the embodiments of the present invention as disclosed above are also possible. For example, it is noted that as utilized herein the terms modulation and error correction include any available modulation techniques and error correction techniques available for the data be transmitted. In addition, as noted above the quality of the received signal can be measured utilizing any suitable metric, including, but not limited SNR, bit-error-rate, etc.

As an example of the use of the system, in an emergency services scenario, for example, a chemical tank ruptures in an area close to a large urban area and spreads toxic gases. The local municipal authority engages an emergency alert via ATSC-AVSB as part of its longstanding agreement with local broadcasters. The quality control processing unit 10 commands the transmission of the emergency broadcast into AVSB-mode, which delivers both ½ rate (better) and ¼ rate (best) in an attempt to reach the largest possible broadcast region in order to warn the public. However, because of the variability of local weather conditions, it is impossible to know for sure the coverage area that the transmitters will actual reach. In the present invention, the feedback of the quality of reception signal via the communications channel 29 is utilized by the quality control processing unit 10 to determine which mode of A-VSB will provide the maximum coverage (i.e., broadcast capabilities). Thus, by polling receivers, the quality control processing unit can determine which is the optimal mode of A-VSB to use to transmit the data. Furthermore, this polling can be performed periodically so as to allow for future corrections due to changes in the weather.

Another example of the use of the present invention is if reception is strong is all desired areas of the broadcast region and all of the receiver units are receiving the transmitted signal at a level well above the minimum required level, the quality control processing unit 10 will determine this fact from the quality of reception data obtained from the receiver units 12, and thereafter command for a reduction in the transmit power levels so as to save power and reduce operating costs.

While specific embodiments of, and examples for, the invention are described herein for illustrative purposes, various equivalent modifications are possible within the scope of the invention, as those skilled in the relevant art will recognize.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

What is claimed is:

1. A method of transmitting a digital data stream to a receiver unit, said method comprising:
modulating a digital data stream in accordance with a modulation technique so as to generate a modulated digital data stream;
providing said modulated digital data stream to a transmitter unit, said transmitter unit operable for transmitting said modulated digital data stream;
receiving said transmitted digital data stream by said receiver unit, said receiver unit generating signal reception data indicating the quality of reception of the modulated digital data stream; and
providing said signal reception data to a quality control processing unit via a communication channel;
wherein said quality control processing unit analyzes said signal reception data to determine if the quality of reception of the modulation digital data stream by said receiver unit is below a predefined level.

2. The method of claim 1, further comprising the step adjusting the modulation technique applied to said digital data stream if said quality control processing unit determines said quality of reception of the modulation digital data stream by said receiver unit is below a predefined level.

3. The method of claim 1, wherein said digital data stream comprises an OTA ATSC broadcast stream.

4. The method of claim 1, wherein said communication channel comprises a wide-area-network (WAN).

5. The method of claim 1, wherein said data indicating the quality of reception of the modulated digital data stream include at least one of the signal-to-noise ration of the received digital data stream or the bit-error-rate of the received digital data stream.

6. The method of claim 1, wherein said modulation technique includes at one of A-VSB, E-VSB, 8-VSB, 4-VSB and 2-VSB.

7. A system for transmitting a digital data stream, said system including:
a modulation unit for receiving said digital data stream and modulating said digital data stream in accordance with a modulation technique;
a transmitter unit for transmitting said modulated digital data stream;
a receiver unit for receiving said transmitted modulated digital data stream, said receiver unit generating signal reception data indicating the quality of reception of the modulated digital data stream;
a quality control processing unit for analyzing said signal reception data to determine if the quality of reception of the modulated digital data stream received by said receiver unit is below a predefined level; and
a communication channel for coupling said receiver unit to said quality control processing unit, said signal reception data being provided to said quality control processing unit via said communication channel.

8. The system of claim 7, wherein said quality control processing unit will adjust the modulation technique applied to said digital data stream by the modulation unit if said quality control processing unit determines said quality of reception of the modulation digital data stream by said receiver unit is below a predefined level.

9. The system of claim 7, wherein said digital data stream comprises an OTA ATSC broadcast stream.

10. The system of claim 7, wherein said communication channel comprises a wide-area-network (WAN).

11. The system of claim 7, wherein said data indicating the quality of reception of the modulated digital data stream include at least one of the signal-to-noise ration of the received digital data stream or the bit-error-rate of the received digital data stream.

12. The system of claim 7, wherein said modulation technique includes at one of A-VSB, E-VSB, 8-VSB, 4-VSB and 2-VSB.
